(19) United States
(12) Patent Application Publication
(10) Pub. No.: US 2026/0101131 A1
(43) Pub. Date: Apr. 9, 2026

(54) SYSTEMS AND METHODS FOR MANUFACTURING CURVED SPEAKER GRILL

(71) Applicant: SONOS, INC., Goleta, CA (US)

(72) Inventors: Kevin ASH, San Diego, CA (US); Wei Hean LIEW, Boston, MA (US); Linduo LIU, Shanghai (CN); Louis Jerome LUNDELL, Santa Barbara, CA (US); Kylie MUNTEAN, Santa Barbara, CA (US); Jonathan OSWAKS, Thousands Oak, CA (US)

(21) Appl. No.: 19/114,923

(22) PCT Filed: Sep. 30, 2022
(86) PCT No.: PCT/CN2022/123249

§ 371 Date: Mar. 25, 2025

(51) Int. Cl. H04R 1/02

(52) U.S. Cl. CPC H04R 1/023; H04R 2201/029; H04R 2400/11

(57) ABSTRACT

A method for mounting a flexible speaker grill on to an audio speaker housing, the method comprising: punching a plurality of holes through a thin, flat, piece of plastic to create a grill surface; affixing a scrim cloth to the rear surface of the grill surface; affixing two frame members to the grill surface, each said frame member to an opposite end of the grill surface to create a grill assembly; wrapping the grill assembly around an audio speaker housing with the scrim cloth toward the inside such that the grill assembly conforms to the adjacent surface of the speaker housing; mounting the two frame members to the speaker housing by screws into threaded holes in the speaker housing.

### FIELD OF THE DISCLOSURE

The disclosure is related to consumer goods and, more particularly, to methods, systems, products, features, services, and other elements directed to manufacturing media playback devices or some aspect thereof.

### BACKGROUND

Options for accessing and listening to digital audio in an out-loud setting were limited until in 2003, when SONOS, Inc. filed for one of its first patent applications, entitled “Method for Synchronizing Audio Playback between Multiple Networked Devices,” and began offering a media playback system for sale in 2005. The Sonos Wireless HiFi System enables people to experience music from many sources via one or more networked playback devices. Through a software control application installed on a smartphone, tablet, or computer, one can play what he or she wants in any room that has a networked playback device. Additionally, using the controller, for example, different songs can be streamed to each room with a playback device, rooms can be grouped together for synchronous playback, or the same song can be heard in all rooms synchronously.

Given the ever growing interest in digital media, there continues to be a need to develop consumer-accessible technologies to further enhance the listening experience.

### BRIEF DESCRIPTION OF THE DRAWINGS

Features, aspects, and advantages of the presently disclosed technology may be better understood with regard to the following description, appended claims, and accompanying drawings where:

FIG. 1 shows an example media playback system configuration in which certain embodiments may be practiced;

FIG. 2 shows a functional block diagram of an example playback device;

FIG. 3 shows a functional block diagram of an example control device;

FIG. 4 shows an example controller interface;

FIGS. 5A and 5B show a grill subassembly in accordance with an embodiment of the invention;

FIGS. 5C and 5D shows adhesive applied between a grill surface and frame member in accordance with an embodiment of the invention;

FIGS. 6A and 6B shows alignment of a grill subassembly with a speaker housing in accordance with an embodiment of the invention;

FIGS. 7A and 7B show a centering post and curved front panel of a grill subassembly in accordance with an embodiment of the invention;

FIG. 8 is a flow chart showing a process for manufacturing a curved speaker grill on a speaker housing in accordance with an embodiment of the invention;

The drawings are for the purpose of illustrating example embodiments, but it is understood that the inventions are not limited to the arrangements and instrumentality shown in the drawings.

### DETAILED DESCRIPTION

### I. Overview

Many embodiments of the invention described herein involve mounting a curved speaker grill on a playback device. Considerations for designing such a component can include cost, removability/repairability, and aesthetics. It is often desirable to minimize manufacturing/construction costs for consumer products. Additionally, many companies, for sustainability and consumer support, prefer to provide reparability options for components of a product. For consumer appeal, aesthetics can be important in presenting a uniform and pleasing appearance. Such considerations can guide design choices for manufacturing components in accordance with embodiments of the invention as described here.

The speaker grill can have small openings to allow air and sound waves to pass through. In some embodiments, for example, a grill subassembly can include a grill surface, one or more locating pins, and one or more hook-and-loop fasteners. The grill subassembly may initially be flat, and wrapped to conform to a curved speaker housing while the hook-and-loop fastener and adhesive secure it to the speaker housing. In several embodiments, the grill subassembly is mounted to plastic frame members that are removable from the speaker housing and can facilitate removal and replacement of the grill subassembly from the speaker housing.

While some examples described herein may refer to functions performed by given actors such as “users” and/or other entities, it should be understood that this is for purposes of explanation only. The claims should not be interpreted to require action by any such example actor unless explicitly required by the language of the claims themselves. It will be understood by one of ordinary skill in the art that this disclosure includes numerous other embodiments. II. Example Operating Environment

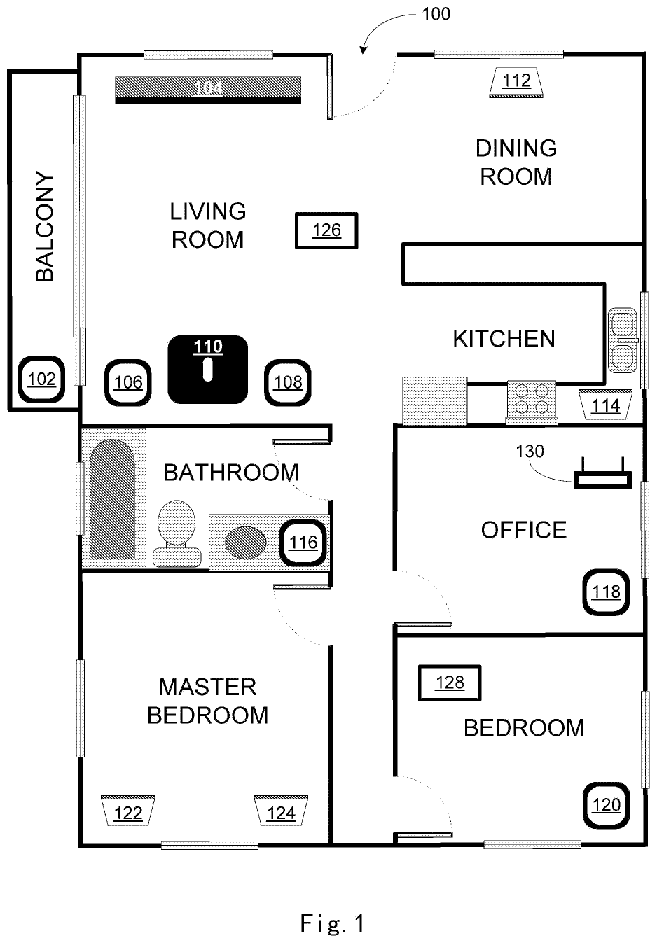

FIG. 1 shows an example configuration of a media playback system 100 in which one or more embodiments disclosed herein may be practiced or implemented. The media playback system 100 as shown is associated with an example home environment having several rooms and spaces, such as for example, a master bedroom, an office, a dining room, and a living room. As shown in the example of FIG. 1, the media playback system 100 includes playback devices 102-124, control devices 126 and 128, and a wired or wireless network router 130.

Further discussions relating to the different components of the example media playback system 100 and how the different components may interact to provide a user with a media experience may be found in the following sections. While discussions herein may generally refer to the example media playback system 100, technologies described herein are not limited to applications within, among other things, the home environment as shown in FIG. 1. For instance, the technologies described herein may be useful in environments where multi-zone audio may be desired, such as, for example, a commercial setting like a restaurant, mall or airport, a vehicle like a sports utility vehicle (SUV), bus or car, a ship or boat, an airplane, and so on.

### a. Example Playback Devices

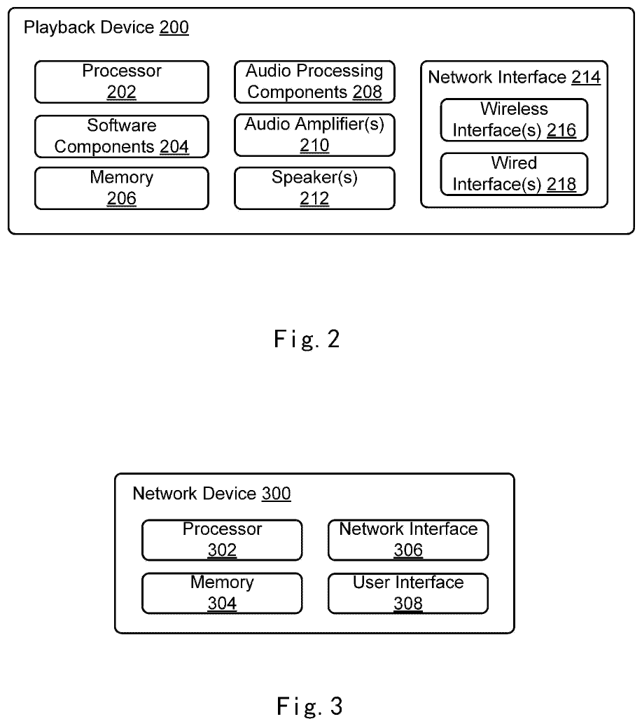

FIG. 2 shows a functional block diagram of an example playback device 200 that may be configured to be one or more of the playback devices 102-124 of the media playback system 100 of FIG. 1. The playback device 200 may include a processor 202, software components 204, memory 206, audio processing components 208, audio amplifier(s) 210, speaker(s) 212, and a network interface 214 including wireless interface(s) 216 and wired interface(s) 218. In one case, the playback device 200 may not include the speaker(s) 212, but rather a speaker interface for connecting the playback device 200 to external speakers. In another case, the playback device 200 may include neither the speaker(s) 212 nor the audio amplifier(s) 210, but rather an audio interface for connecting the playback device 200 to an external audio amplifier or audio-visual receiver.

In one example, the processor 202 may be a clock-driven computing component configured to process input data according to instructions stored in the memory 206. The memory 206 may be a tangible computer-readable medium configured to store instructions executable by the processor 202. For instance, the memory 206 may be data storage that can be loaded with one or more of the software components 204 executable by the processor 202 to achieve certain functions. In one example, the functions may involve the playback device 200 retrieving audio data from an audio source or another playback device. In another example, the functions may involve the playback device 200 sending audio data to another device or playback device on a network. In yet another example, the functions may involve pairing of the playback device 200 with one or more playback devices to create a multi-channel audio environment.

Certain functions may involve the playback device 200 synchronizing playback of audio content with one or more other playback devices. During synchronous playback, a listener will preferably not be able to perceive time-delay differences between playback of the audio content by the playback device 200 and the one or more other playback devices. U.S. Pat. No. 8,234,395 entitled, “System and method for synchronizing operations among a plurality of independently clocked digital data processing devices,” which is hereby incorporated by reference, provides in more detail some examples for audio playback synchronization among playback devices.

The memory 206 may further be configured to store data associated with the playback device 200, such as one or more zones and/or zone groups the playback device 200 is a part of, audio sources accessible by the playback device 200, or a playback queue that the playback device 200 (or some other playback device) may be associated with. The data may be stored as one or more state variables that are periodically updated and used to describe the state of the playback device 200. The memory 206 may also include the data associated with the state of the other devices of the media system, and shared from time to time among the devices so that one or more of the devices have the most recent data associated with the system. Other embodiments are also possible.

The audio processing components 208 may include one or more digital-to-analog converters (DAC), an audio preprocessing component, an audio enhancement component or a digital signal processor (DSP), and so on. In one embodiment, one or more of the audio processing components 208 may be a subcomponent of the processor 202. In one example, audio content may be processed and/or intentionally altered by the audio processing components 208 to produce audio signals. The produced audio signals may then be provided to the audio amplifier(s) 210 for amplification and playback through speaker(s) 212. Particularly, the audio amplifier(s) 210 may include devices configured to amplify audio signals to a level for driving one or more of the speakers 212. The speaker(s) 212 may include an individual transducer (e.g., a “driver”) or a complete speaker system involving an enclosure with one or more drivers. A particular driver of the speaker(s) 212 may include, for example, a subwoofer (e.g., for low frequencies), a mid-range driver (e.g., for middle frequencies), and/or a tweeter (e.g., for high frequencies). In some cases, each transducer in the one or more speakers 212 may be driven by an individual corresponding audio amplifier of the audio amplifier(s) 210. In addition to producing analog signals for playback by the playback device 200, the audio processing components 208 may be configured to process audio content to be sent to one or more other playback devices for playback.

Audio content to be processed and/or played back by the playback device 200 may be received from an external source, such as via an audio line-in input connection (e.g., an auto-detecting 3.5 mm audio line-in connection) or the network interface 214.

The network interface 214 may be configured to facilitate a data flow between the playback device 200 and one or more other devices on a data network. As such, the playback device 200 may be configured to receive audio content over the data network from one or more other playback devices in communication with the playback device 200, network devices within a local area network, or audio content sources over a wide area network such as the Internet. In one example, the audio content and other signals transmitted and received by the playback device 200 may be transmitted in the form of digital packet data containing an Internet Protocol (IP)-based source address and IP-based destination addresses. In such a case, the network interface 214 may be configured to parse the digital packet data such that the data destined for the playback device 200 is properly received and processed by the playback device 200.

As shown, the network interface 214 may include wireless interface(s) 216 and wired interface(s) 218. The wireless interface(s) 216 may provide network interface functions for the playback device 200 to wirelessly communicate with other devices (e.g., other playback device(s), speaker(s), receiver(s), network device(s), control device(s) within a data network the playback device 200 is associated with) in accordance with a communication protocol (e.g., any wireless standard including IEEE 802.11a, 802.11b, 802.11g, 802.11n, 802.11ac, 802.15, 4G mobile communication standard, and so on). The wired interface(s) 218 may provide network interface functions for the playback device 200 to communicate over a wired connection with other devices in accordance with a communication protocol (e.g., IEEE 802.3). While the network interface 214 shown in FIG. 2 includes both wireless interface(s) 216 and wired interface(s) 218, the network interface 214 may in some embodiments include only wireless interface(s) or only wired interface(s).

In one example, the playback device 200 and one other playback device may be paired to play two separate audio components of audio content. For instance, playback device 200 may be configured to play a left channel audio component, while the other playback device may be configured to play a right channel audio component, thereby producing or enhancing a stereo effect of the audio content. The paired playback devices (also referred to as “bonded playback devices”) may further play audio content in synchrony with other playback devices.

In another example, the playback device 200 may be sonically consolidated with one or more other playback devices to form a single, consolidated playback device. A consolidated playback device may be configured to process and reproduce sound differently than an unconsolidated playback device or playback devices that are paired, because a consolidated playback device may have additional speaker drivers through which audio content may be rendered. For instance, if the playback device 200 is a playback device designed to render low frequency range audio content (i.e. a subwoofer), the playback device 200 may be consolidated with a playback device designed to render full frequency range audio content. In such a case, the full frequency range playback device, when consolidated with the low frequency playback device 200, may be configured to render only the mid and high frequency components of audio content, while the low frequency range playback device 200 renders the low frequency component of the audio content. The consolidated playback device may further be paired with a single playback device or yet another consolidated playback device.

By way of illustration, SONOS, Inc. presently offers (or has offered) for sale certain playback devices including a “PLAY:1,” “PLAY:3,” “PLAY:5,” “PLAYBAR,” “CONNECT:AMP,” “CONNECT,” and “SUB.” Any other past, present, and/or future playback devices may additionally or alternatively be used to implement the playback devices of example embodiments disclosed herein. Additionally, it is understood that a playback device is not limited to the example illustrated in FIG. 2 or to the SONOS product offerings. For example, a playback device may include a wired or wireless headphone. In another example, a playback device may include or interact with a docking station for personal mobile media playback devices. In yet another example, a playback device may be integral to another device or component such as a television, a lighting fixture, or some other device for indoor or outdoor use.

### b. Example Playback Zone Configurations

Referring back to the media playback system 100 of FIG. 1, the environment may have one or more playback zones, each with one or more playback devices. The media playback system 100 may be established with one or more playback zones, after which one or more zones may be added, or removed to arrive at the example configuration shown in FIG. 1. Each zone may be given a name according to a different room or space such as an office, bathroom, master bedroom, bedroom, kitchen, dining room, living room, and/or balcony. In one case, a single playback zone may include multiple rooms or spaces. In another case, a single room or space may include multiple playback zones.

As shown in FIG. 1, the balcony, dining room, kitchen, bathroom, office, and bedroom zones each have one playback device, while the living room and master bedroom zones each have multiple playback devices. In the living room zone, playback devices 104, 106, 108, and 110 may be configured to play audio content in synchrony as individual playback devices, as one or more bonded playback devices, as one or more consolidated playback devices, or any combination thereof. Similarly, in the case of the master bedroom, playback devices 122 and 124 may be configured to play audio content in synchrony as individual playback devices, as a bonded playback device, or as a consolidated playback device.

In one example, one or more playback zones in the environment of FIG. 1 may each be playing different audio content. For instance, the user may be grilling in the balcony zone and listening to hip hop music being played by the playback device 102 while another user may be preparing food in the kitchen zone and listening to classical music being played by the playback device 114. In another example, a playback zone may play the same audio content in synchrony with another playback zone. For instance, the user may be in the office zone where the playback device 118 is playing the same rock music that is being playing by playback device 102 in the balcony zone. In such a case, playback devices 102 and 118 may be playing the rock music in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in previously referenced U.S. Pat. No. 8,234,395.

As suggested above, the zone configurations of the media playback system 100 may be dynamically modified, and in some embodiments, the media playback system 100 supports numerous configurations. For instance, if a user physically moves one or more playback devices to or from a zone, the media playback system 100 may be reconfigured to accommodate the change(s). For instance, if the user physically moves the playback device 102 from the balcony zone to the office zone, the office zone may now include both the playback device 118 and the playback device 102. The playback device 102 may be paired or grouped with the office zone and/or renamed if so desired via a control device such as the control devices 126 and 128. On the other hand, if the one or more playback devices are moved to a particular area in the home environment that is not already a playback zone, a new playback zone may be created for the particular area.

Further, different playback zones of the media playback system 100 may be dynamically combined into zone groups or split up into individual playback zones. For instance, the dining room zone and the kitchen zone 114 may be combined into a zone group for a dinner party such that playback devices 112 and 114 may render audio content in synchrony. On the other hand, the living room zone may be split into a television zone including playback device 104, and a listening zone including playback devices 106, 108, and 110, if the user wishes to listen to music in the living room space while another user wishes to watch television.

### c. Example Control Devices

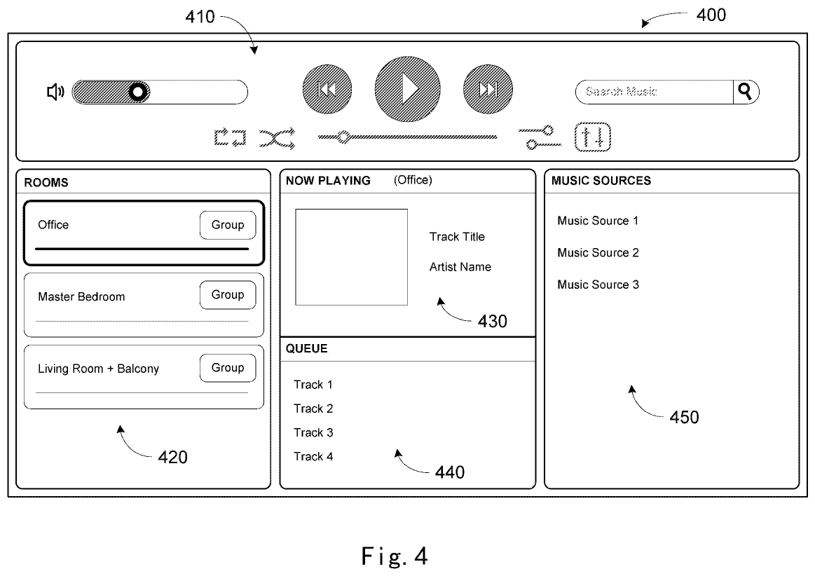

FIG. 3 shows a functional block diagram of an example control device 300 that may be configured to be one or both of the control devices 126 and 128 of the media playback system 100. As shown, the control device 300 may include a processor 302, memory 304, a network interface 306, and a user interface 308. In one example, the control device 300 may be a dedicated controller for the media playback system 100. In another example, the control device 300 may be a network device on which media playback system controller application software may be installed, such as for example, an iPhone™, iPad ™ or any other smart phone, tablet or network device (e.g., a networked computer such as a PC or Mac™).

The processor 302 may be configured to perform functions relevant to facilitating user access, control, and configuration of the media playback system 100. The memory 304 may be configured to store instructions executable by the processor 302 to perform those functions. The memory 304 may also be configured to store the media playback system controller application software and other data associated with the media playback system 100 and the user.

In one example, the network interface 306 may be based on an industry standard (e.g., infrared, radio, wired standards including IEEE 802.3, wireless standards including IEEE 802.11a, 802.11b, 802.11g, 802.11n, 802.11ac, 802.15, 4G mobile communication standard, and so on). The network interface 306 may provide a means for the control device 300 to communicate with other devices in the media playback system 100. In one example, data and information (e.g., such as a state variable) may be communicated between control device 300 and other devices via the network interface 306. For instance, playback zone and zone group configurations in the media playback system 100 may be received by the control device 300 from a playback device or another network device, or transmitted by the control device 300 to another playback device or network device via the network interface 306. In some cases, the other network device may be another control device.

Playback device control commands such as volume control and audio playback control may also be communicated from the control device 300 to a playback device via the network interface 306. As suggested above, changes to configurations of the media playback system 100 may also be performed by a user using the control device 300. The configuration changes may include adding/removing one or more playback devices to/from a zone, adding/removing one or more zones to/from a zone group, forming a bonded or consolidated player, separating one or more playback devices from a bonded or consolidated player, among others. Accordingly, the control device 300 may sometimes be referred to as a controller, whether the control device 300 is a dedicated controller or a network device on which media playback system controller application software is installed.

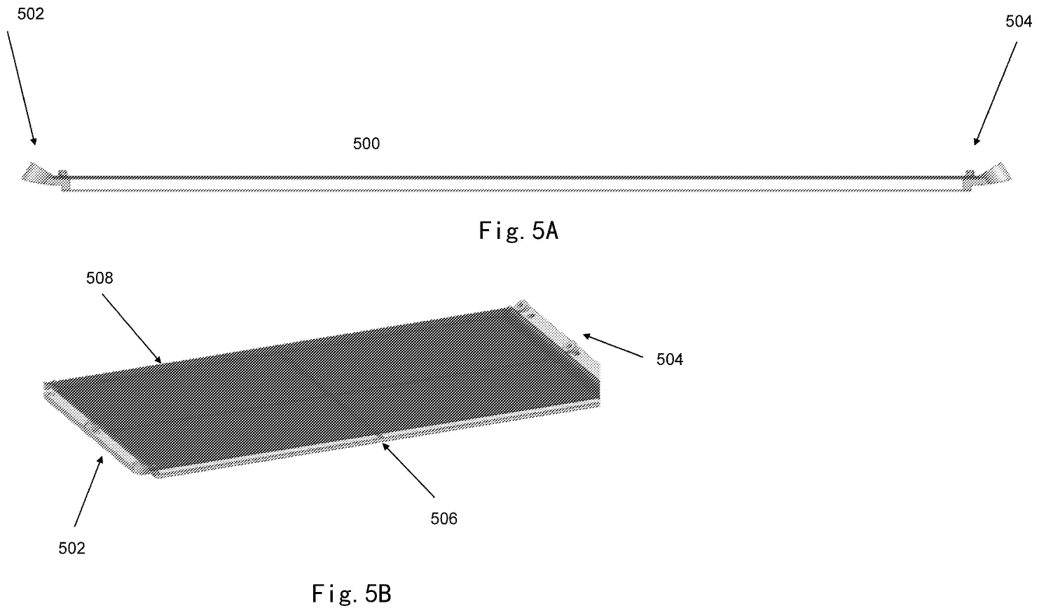

The user interface 308 of the control device 300 may be configured to facilitate user access and control of the media playback system 100, by providing a controller interface such as the controller interface 400 shown in FIG. 4. The controller interface 400 includes a playback control region 410, a playback zone region 420, a playback status region 430, a playback queue region 440, and an audio content sources region 450. The controller interface 400 as shown is just one example of a user interface that may be provided on a network device such as the control device 300 of FIG. 3 (and/or the control devices 126 and 128 of FIG. 1) and accessed by users to control a media playback system such as the media playback system 100. Other user interfaces of varying formats, styles, and interactive sequences may alternatively be implemented on one or more network devices to provide comparable control access to a media playback system.

The playback control region 410 may include selectable (e.g., by way of touch or by using a cursor) icons to cause playback devices in a selected playback zone or zone group to play or pause, fast forward, rewind, skip to next, skip to previous, enter/exit shuffle mode, enter/exit repeat mode, enter/exit cross fade mode. The playback control region 410 may also include selectable icons to modify equalization settings, and playback volume, among other possibilities.

The playback zone region 420 may include representations of playback zones within the media playback system 100. In some embodiments, the graphical representations of playback zones may be selectable to bring up additional selectable icons to manage or configure the playback zones in the media playback system, such as a creation of bonded zones, creation of zone groups, separation of zone groups, and renaming of zone groups, among other possibilities.

For example, as shown, a “group” icon may be provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone will be configured to play audio content in synchrony with the playback device(s) in the particular zone. Analogously, a “group” icon may be provided within a graphical representation of a zone group. In this case, the “group” icon may be selectable to bring up options to deselect one or more zones in the zone group to be removed from the zone group. Other interactions and implementations for grouping and ungrouping zones via a user interface such as the controller interface 400 are also possible. The representations of playback zones in the playback zone region 420 may be dynamically updated as playback zone or zone group configurations are modified.

The playback status region 430 may include graphical representations of audio content that is presently being played, previously played, or scheduled to play next in the selected playback zone or zone group. The selected playback zone or zone group may be visually distinguished on the user interface, such as within the playback zone region 420 and/or the playback status region 430. The graphical representations may include track title, artist name, album name, album year, track length, and other relevant information that may be useful for the user to know when controlling the media playback system via the user interface 400.

The playback queue region 440 may include graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device.

In one example, a playlist may be added to a playback queue, in which case information corresponding to each audio item in the playlist may be added to the playback queue. In another example, audio items in a playback queue may be saved as a playlist. In a further example, a playback queue may be empty, or populated but “not in use” when the playback zone or zone group is playing continuously streaming audio content, such as Internet radio that may continue to play until otherwise stopped, rather than discrete audio items that have playback durations. In an alternative embodiment, a playback queue can include Internet radio and/or other streaming audio content items and be “in use” when the playback zone or zone group is playing those items. Other examples are also possible.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped. Other examples are also possible.

Referring back to the controller interface 400 of FIG. 4, the graphical representations of audio content in the playback queue region 440 may include track titles, artist names, track lengths, and other relevant information associated with the audio content in the playback queue. In one example, graphical representations of audio content may be selectable to bring up additional selectable icons to manage and/or manipulate the playback queue and/or audio content represented in the playback queue. For instance, a represented audio content may be removed from the playback queue, moved to a different position within the playback queue, or selected to be played immediately, or after any currently playing audio content, among other possibilities. A playback queue associated with a playback zone or zone group may be stored in a memory on one or more playback devices in the playback zone or zone group, on a playback device that is not in the playback zone or zone group, and/or some other designated device.

The audio content sources region 450 may include graphical representations of selectable audio content sources from which audio content may be retrieved and played by the selected playback zone or zone group. Discussions pertaining to audio content sources may be found in the following section.

### d. Example Audio Content Sources

As indicated previously, one or more playback devices in a zone or zone group may be configured to retrieve for playback audio content (e.g. according to a corresponding URI or URL for the audio content) from a variety of available audio content sources. In one example, audio content may be retrieved by a playback device directly from a corresponding audio content source (e.g., a line-in connection). In another example, audio content may be provided to a playback device over a network via one or more other playback devices or network devices.

Example audio content sources may include a memory of one or more playback devices in a media playback system such as the media playback system 100 of FIG. 1, local music libraries on one or more network devices (such as a control device, a network-enabled personal computer, or a networked-attached storage (NAS), for example), streaming audio services providing audio content via the Internet (e.g., the cloud), or audio sources connected to the media playback system via a line-in input connection on a playback device or network devise, among other possibilities.

In some embodiments, audio content sources may be regularly added or removed from a media playback system such as the media playback system 100 of FIG. 1. In one example, an indexing of audio items may be performed whenever one or more audio content sources are added, removed or updated. Indexing of audio items may involve scanning for identifiable audio items in all folders/directory shared over a network accessible by playback devices in the media playback system, and generating or updating an audio content database containing metadata (e.g., title, artist, album, track length, among others) and other associated information, such as a URI or URL for each identifiable audio item found. Other examples for managing and maintaining audio content sources may also be possible.

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

### III. Manufacturing a Playback Device Having a Curved Speaker Grill

### a. Grill Subassembly

As discussed above, several embodiments described herein involve manufacturing a playback device having a curved speaker grill. In many embodiments, the speaker grill can be formed of a thin, flexible material that is initially flat and becomes curved to conform to the speaker housing of the playback device as it is attached to the speaker housing. A set of components that includes a grill surface and attachment features for mounting onto the speaker housing can be referred to as a grill subassembly.

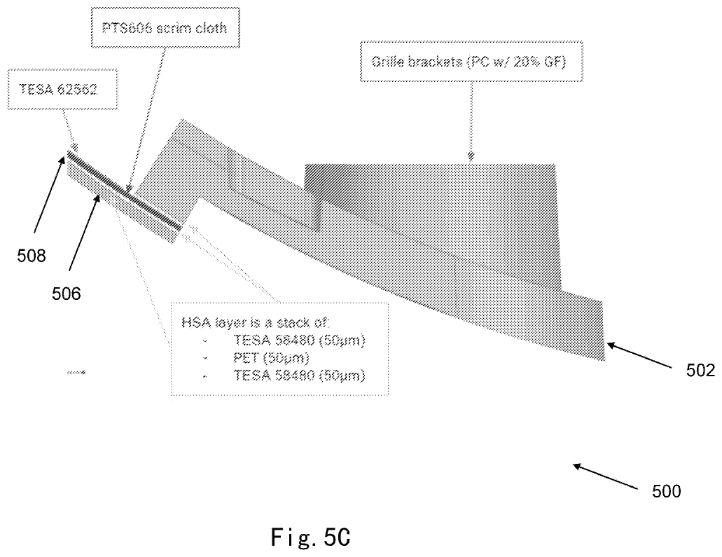

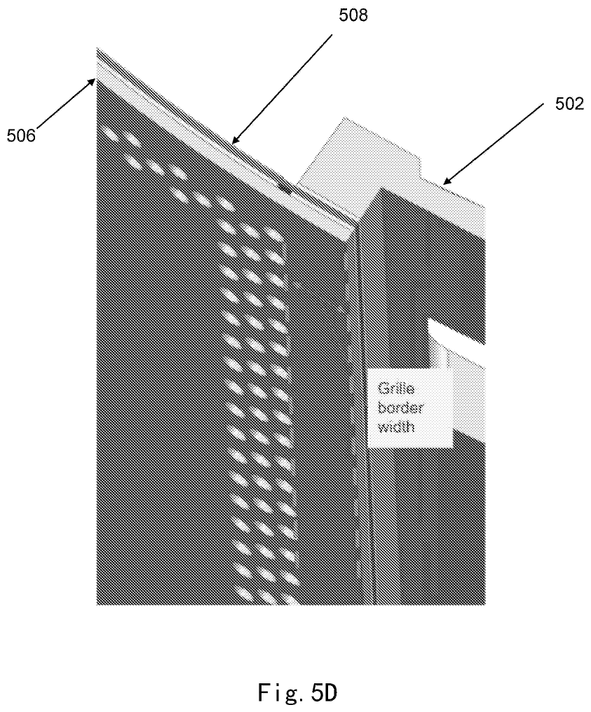

A grill subassembly shown before mounting to a speaker housing in accordance with several embodiments of the invention is illustrated in FIGS. 5A and 5B. As shown, the grill subassembly 500 may be initially flat. The grill subassembly 500 includes frame members 502 and 504, and a grill surface subassembly that includes a grill surface 506 and a scrim cloth 508 layered behind the grill surface 506. Frame members 502 and 504 are attached to the grill surface subassembly at the far left and right ends of the grill subassembly 500. As shown, the grill surface subassembly of the grill subassembly 500 may have a rectangular shape. In some embodiments, the shape of the grill surface (as well as the frame members 502 and 504) may vary based on the industrial design parameters of the playback device. While the embodiments described and shown herein generally involve the scrim cloth 508, one of ordinary skill in the art will appreciate that some embodiments may not include the scrim cloth 508, or may include an alternate material and/or component in place of the scrim cloth 508.

In some embodiments of the invention, the frame members 502 and 504 are made of plastic. While they are described here as plastic, they can be another rigid material, such as other types of polymer, or metal. The frame members 502 and 504 have mounting features for attachment to a speaker housing, which can be implemented in a variety of ways according to various embodiments of the invention. In some embodiments, the frame members 502 and 504 have holes through which screws or bolts can be inserted and threaded into the speaker housing. In other embodiments, the frame members 502 and 504 may utilize other types of mounting features, such as, but not limited to, snaps, hooks, etc. to attach to the speaker housing. For example, with snaps or hooks, one side of the feature can be on the frame member while the complementary engagement feature is on the speaker housing in a corresponding location.

In some embodiments of the invention, the frame members 502 and 504 may be attached to the grill surface 506 on the front side of the grill surface subassembly, or to the scrim cloth 508 on the back side of the grill surface subassembly, as will be discussed further below. The grill surface 506 and the frame members 502 and 504 may be attached by an adhesive. The adhesive can be, for example, heat sensitive adhesive (HSA) or pressure sensitive adhesive (PSA). Other types of adhesives can include liquid glue, which may be brushed or sprayed on. In some embodiments, the grill surface 506 and the frame members 502 and 504 may be attached via other means, such as by stapling, ultrasonic welding, insert injection molding, or any of a variety of other ways of joining parts. With insert molding, the grill surface 506 can be placed in a mold before material is injected into the mold to form the frame member(s).

The grill surface 506 may be a thin sheet of material with grill holes across a large portion of the grill surface 506. In some embodiments of the invention, the thin sheet of material is made of plastic. While it is described here as plastic, it can be another flexible material, such as other types of polymer, or metal. The grill holes may be punched, drilled, or otherwise produced via methods suitable for the material. The grill holes may be placed uniformly or placed according to varying patterns. In some embodiments, the grill surface 506 is 0.375 mm thick. In other embodiments, the thickness can be up to 0.43 mm. One constraint to the thickness is that the grill surface 506 should be thin enough that it is flexible enough to bend and conform around another curved surface. Different thickness ranges may be possible for a grill surface 506 of different material compositions, as well as different grill hole sizes, grill hole density, and grill hole patterns, among other possibilities.

In some embodiments of the invention, the back side of the grill surface subassembly of the grill subassembly 500 includes the scrim cloth 508 that can additionally or alternatively be attached to the frame members 502 and 504 by an adhesive or other means. A scrim cloth that is an “acoustically transparent” fabric, i.e., having low acoustic impedance, or little or negligible effect on sound or acoustic waves passing through it, can be desirable for obscuring the visibility of objects behind it. Such fabrics can be a fine woven fabric (e.g., plastic or cloth) with a loose weave that does not significantly affect air pressure, but has a solid enough appearance to prevent “read through” or the ability to see objects that are behind it.

FIGS. 5C and 5D illustrate frame member 502, grill surface 506, and scrim cloth 508 components of the grill subassembly 500 relative to each other according to an embodiment of the invention. In the illustrated embodiment, the scrim cloth 508 is attached to the frame member 502 with adhesive, while on its other side the scrim cloth 508 is attached to the grill surface 506 with adhesive. In other words, referring back to FIGS. 5A and 5B, a first edge of the scrim cloth 508 may be attached between the frame member 502 and a first edge of the grill surface 506, and a second edge of the scrim cloth 508 may be attached between the frame member 504 and a second edge of the grill surface 506. As indicated above, the frame members 502, 504, the scrim cloth 508, and the grill surface 506 may be attached via one or more types of adhesives and/or other attachment means to form the grill subassembly 500.

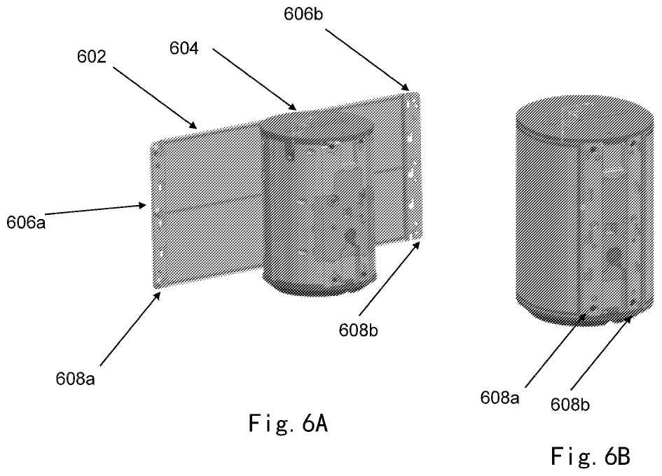

FIGS. 6A and 6B illustrates placement of a grill subassembly 602 onto a speaker housing 604 in accordance with an embodiment of the invention. The grill subassembly 602 may be an example of the grill subassembly 500 described above in connection to FIGS. 5A-5D. FIG. 6A shows aligning the grill subassembly 602, while it is still flat, with its designated placement area on the speaker housing 604.

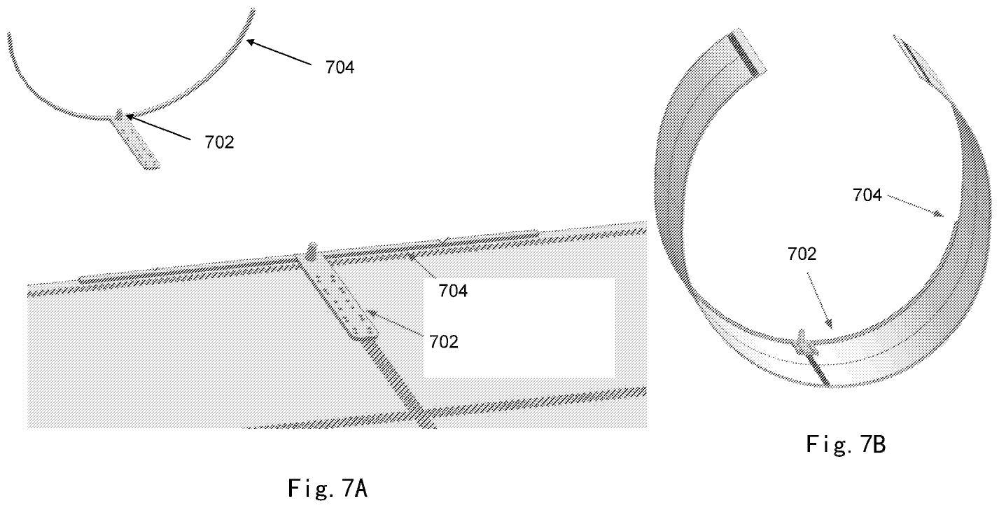

As shown in FIGS. 7A and 7B, the grill subassembly 602/500 may further include a front panel 704 that can be attached to an edge of the grill surface subassembly perpendicular to and substantially equidistant from the edges of the grill surface subassembly that are attached to the frame members 502 and 504. The front panel may be attached to the grill subassembly 602/500 via one or more of the attachment methods described herein in connection to frame members 502 and 504. The front panel 704 may include one or more centering posts 702 that protrude from the rear and are designed to align with centering receiving holes on the speaker housing 604.

As shown in FIGS. 7A and 7B the front panel 704 may have a curved profile. The front panel 704 can be a thin and flexible material, such as plastic, that is molded into a curved shape that matches the shape of the corresponding area on the speaker housing 604 where it will contact. The front panel 704 can be attached to the grill subassembly 602/500 while the grill subassembly 602/500 is flat, as shown in FIG. 7A, and can rebound to its curved shape once attached, as shown in FIG. 7B. The curved shape that it provides to the grill subassembly 602/500 can aid in holding the grill profile tight to the speaker housing 604.

FIG. 6B shows the grill subassembly 602 wrapped around the speaker housing 604 and with the frame members 606a and 606b aligned in place to be secured to the speaker housing 604. Mounting holes 608a and 608b of the frame members 606a and 606b, respectively, are aligned with holes in the speaker housing 604. The aligned holes in the speaker housing 604 may be threaded such that screws or bolts can be inserted and threaded into the speaker housing 604, through the mounting holes 608a and 608b of the frame members, to secure the grill subassembly 602 to the speaker housing 604. In some additional embodiments, a rear panel can be attached to cover the frame members 606a and 606b and/or obscure holes (e.g., mounting holes 608a and 608b) used to attach the frame members to the speaker housing. The rear panel can be attached, for example, by inserting hooks, clips, or anchors of the rear panel into receiving slots in the frame members or speaker housing. Processes for manufacturing and attaching a playback device with a curved speaker grill are discussed next.

### b. Processes for Manufacturing Playback Device with Curved Speaker Grill

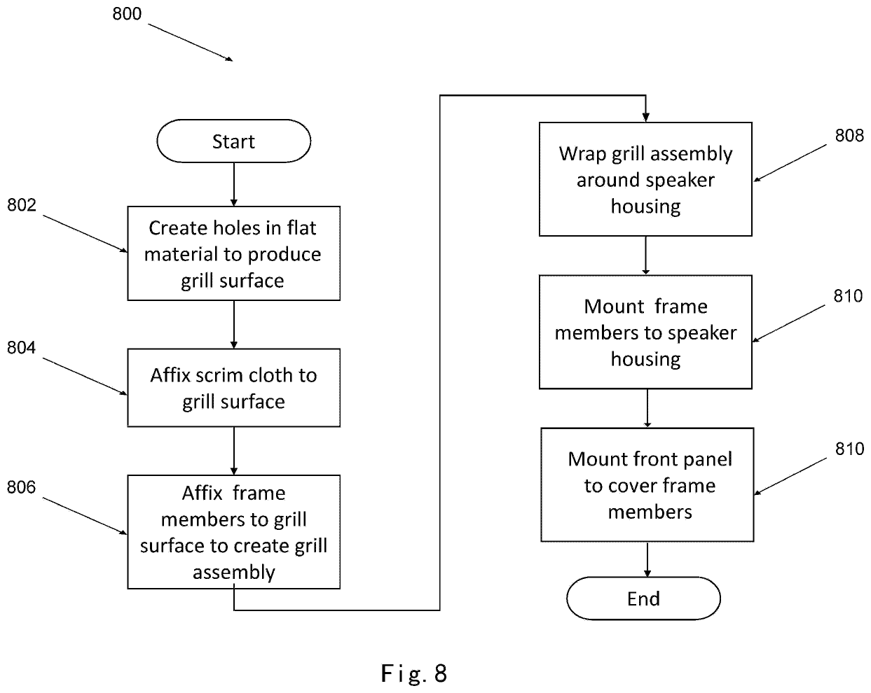

A process for mounting a speaker grill subassembly to a speaker housing in accordance with an embodiment of the invention is illustrated in FIG. 8.

The process 800 includes creating (802) holes in a flat piece of material to produce a grill surface. In many embodiments of the invention, the flat material is plastic. The flat material may also be rectangular in shape. While it is described here as plastic, it can be another flexible material, such as other types of polymer, or metal. As discussed previously, the grill holes may be punched, drilled, or otherwise produced via methods suitable to the material of the grill surface. The grill holes may be placed uniformly or placed according to varying patterns. The thickness flat piece of material should be thin enough that with the grill holes produced, it is flexible enough to bend and conform around another curved surface.

A scrim cloth is attached (804) to the rear of the grill surface to produce a grill surface subassembly. A scrim cloth that is an “acoustically transparent” fabric, i.e., having low acoustic impedance, or little or negligible effect on sound or acoustic waves passing through it, can be desirable for obscuring the visibility of objects behind it. Such fabrics can be a fine woven fabric (e.g., plastic or cloth) with a loose weave that does not significantly affect air pressure, but has a solid enough appearance to prevent “read through” or the ability to see objects that are behind it. As previously discussed, in some embodiments, the grill surface subassembly may exclude the scrim cloth.

Frame members are attached (806) to the grill surface subassembly via the grill surface and/or the scrim cloth to form a grill subassembly. For instance, two plastic frame members may each be attached to far ends of the grill surface subassembly. As discussed previously, frame members can be plastic or other rigid material, and in some additional embodiments, the frame members can be attached to the grill subassembly by being molded to the grill surface as the frame members are formed. In some other embodiments, the frame members may be attached to the rear side of the scrim cloth, opposite the attachment of the scrim cloth to the grill surface. In many embodiments, the frame members have mounting features for attachment to a speaker housing. For example, the frame members can have holes through which screws or bolts can be inserted and threaded into the speaker housing. Other types of mounting features in various embodiments can include, but are not limited to, snaps, hooks, etc. to attach to the speaker housing. For example, with snaps or hooks, one side of the feature can be on the frame member while the complementary engagement feature is on the speaker housing in a corresponding location.

FIGS. 5A, 5B, 5C, 6A, and 6B discussed above illustrate grill subassemblies in accordance with embodiments of the invention and the relative positioning of the components thereof. The grill surface subassembly and the frame members may be attached by an adhesive. The adhesive can be, for example, heat sensitive adhesive (HSA) or pressure sensitive adhesive (PSA). Other types of adhesives can include liquid glue, which may be brushed or sprayed on. In some embodiments, the grill surface subassembly and the frame members and may be attached via other means, such as by stapling, ultrasonic welding, insert injection molding, or any of a variety of other ways of joining parts. With insert molding, the grill surface of the grill surface subassembly can be placed in a mold before material is injected into the mold to form the frame member(s).

The process 800 includes aligning the grill subassembly to the speaker housing and wrapping (808) it around to conform to the speaker housing. In some embodiments, the grill subassembly includes a front panel with one or more centering posts that protrude from the rear, as described above in connection to FIGS. 7A and 7B. The grill subassembly can be aligned by positioning the centering posts to corresponding receiving holes in the speaker housing, and inserting the centering posts into the receiving holes. In several embodiments, the grill subassembly is bent to conform to the shape of the speaker housing. In some cases, the front panel may be curved to aid in conforming the grill subassembly tightly to the speaker housing.

FIG. 6A illustrates an example of aligning a flat grill subassembly 602 to a speaker housing 604 in accordance with an embodiment of the invention. FIG. 6B shows the grill subassembly bent into a curved shape around the speaker housing. The plastic frame members 606a and 606b are aligned with the holes in the frame members positioned to corresponding mounting holes 608a and 608b, respectively, in the speaker housing.

The process includes mounting (810) the frame members of the grill subassembly to the speaker housing. The frame members may be mounted in any of a variety of ways according to various embodiments of the invention as discussed previously. In some embodiments, the frame members have holes, such that screws or bolts can be fastened through the holes of the grill subassembly into the speaker housing. In some additional embodiments, a front panel can be attached to cover the plastic frame members and/or obscure holes used to attach the frame members to the speaker housing. As discussed previously, the front panel can be attached, for example, by inserting hooks, clips, or anchors of the rear panel into receiving slots in the frame members or speaker housing.

Although a process for manufacturing a speaker grill in accordance with an embodiment of the invention is described above with reference to FIG. 9, one skilled in the art will recognize that other processes for manufacturing a speaker grill that add, remove, combine, and/or reorder steps in the above described process are possible without departing from embodiments of this invention.

### IV. CONCLUSION

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

We claim:

1. A method for mounting a flexible speaker grill on to an audio speaker housing, the method comprising:
punching a plurality of holes through a thin, flat, piece of plastic to create a grill surface;
affixing a scrim cloth to the rear surface of the grill surface;
affixing two frame members to the grill surface, each said frame member to an opposite end of the grill surface to create a grill assembly;
wrapping the grill assembly around an audio speaker housing with the scrim cloth toward the inside such that the grill assembly conforms to the adjacent surface of the speaker housing;
mounting the two frame members to the speaker housing by screws into threaded holes in the speaker housing.

2. The method of claim 1 wherein the piece of plastic is rectangular.

3. The method of claim 1, wherein the frame members are hard plastic.

4. The method of claim 1, wherein affixing two frame members to the grill surface comprises bonding using heat sensitive adhesive.

5. The method of claim 1, wherein affixing two frame members comprises molding the grill surface to the frame members as the frame members are being formed of plastic.

6. The method of claim 1 further comprising:
affixing a front panel having hooks into corresponding receiving slots in the frame members.

7. The method of claim 1, wherein the piece of plastic is less than 0.43 mm thick.

8. The method of claim 1, wherein the scrim cloth is a flexible woven plastic fabric.

9. The method of claim 1, wherein the rear surface of the grill surface further comprises a centering post, and the method further comprises:
aligning the centering post with a corresponding receiving hole in the speaker housing before wrapping the grill assembly around the audio speaker housing.

10. The method of claim 1, wherein the speaker housing is an elliptical cylinder in shape.

11. An audio speaker with a flexible speaker grill attached, comprising:
an audio speaker housing;
a grill assembly wrapped around at least part of the audio speaker housing, the grill assembly comprising:
a grill surface comprising a thin, flat, rectangular piece of plastic;
a scrim cloth affixed to the rear surface of the grill surface;
two frame members affixed to the grill surface, each said frame member to an opposite end of the grill surface to create a grill assembly;
wherein the grill assembly is wrapped around at least part of the audio speaker housing by:
wrapping the grill assembly around the audio speaker housing with the scrim cloth toward the inside such that the grill assembly conforms to the adjacent surface of the speaker housing;
mounting the two frame members to the speaker housing by screws into threaded holes in the speaker housing.

12. The audio speaker of claim 11 wherein the piece of plastic is rectangular.

13. The audio speaker of claim 11, wherein the frame members are hard plastic.

14. The audio speaker of claim 11, wherein the two frame members are affixed to the grill surface by bonding using heat sensitive adhesive.

15. The audio speaker of claim 11, wherein the two frame members are affixed to the grill surface by molding the grill surface to the frame members as the frame members are being formed of plastic.

16. The audio speaker of claim 11 further comprising:
a front panel having hooks inserted into corresponding receiving slots in the frame members.

17. The audio speaker of claim 11, wherein the piece of plastic is less than 0.43 mm thick.

18. The audio speaker of claim 11, wherein the scrim cloth is a flexible woven plastic fabric.

19. The audio speaker of claim 11, wherein the rear surface of the grill surface further comprises a centering post, and the centering post is aligned with a corresponding receiving hole in the speaker housing before wrapping the grill assembly around the audio speaker housing.

20. The audio speaker of claim 11, wherein the speaker housing is an elliptical cylinder in shape.
